(19) United States
(12) Patent Application Publication
(10) Pub. No.: US 2016/0111940 A1
(43) Pub. Date: Apr. 21, 2016

(54) CEILING FAN MOTOR AND CEILING FAN

(71) Applicant: Nidec Corporation, Kyoto (JP)

(72) Inventors: Seiichi OYAMA, Kyoto (JP); Hiroaki SAGARA, Kyoto (JP); Yukinobu SHIRAISHI, Kyoto (JP); Takashi UCHINO, Kyoto (JP)

(21) Appl. No.: 14/847,077

(22) Filed: Sep. 8, 2015

(30) Foreign Application Priority Data
Oct. 15, 2014 (JP) 2014-210634

(51) Int. Cl. H02K 11/00; H02K 7/00; F04D 29/38; F04D 19/00; F04D 25/06; F04D 25/08; H02K 7/08; H02K 5/22

(52) U.S. Cl. CPC H02K 11/001; H02K 11/0073; H02K 7/086; H02K 7/003; H02K 5/22; F04D 19/002; F04D 25/06; F04D 25/088; F04D 29/38

(57) ABSTRACT

A ceiling fan motor includes a shaft, a stator, an upper motor cover, a bearing unit, a lower motor cover, a rotor magnet, and a circuit board arranged below the stator. The upper motor cover is a ferromagnetic body. The circuit board includes a board body, a rotation sensor attached to the board body and opposed to the rotor magnet in an up-down direction, and a circuit component larger in mass than the rotation sensor. If there is defined an imaginary line which is orthogonal, when seen in the up-down direction, to a line interconnecting the rotation sensor and the center axis and which passes through the shaft, a gravity center of the circuit board is positioned in one of two areas of the circuit board divided by the imaginary line, which differs from the other area where the rotation sensor exists.

### BACKGROUND OF THE INVENTION

1. Field of the Invention

The present invention relates to a ceiling fan motor and a ceiling fan.

2. Description of the Related Art

For example, Japanese Patent Application Publication No. 2012-140915 discloses a ceiling fan provided with a circuit board unit. In Japanese Patent Application Publication No. 2012-140915, the circuit board unit is installed below a stator unit.

In the ceiling fan mentioned above, the circuit board unit is arranged below the stator unit. For that reason, if a circuit component having a relatively large mass is attached to a circuit board, it is likely that the radial outward portion of the circuit board is deflected by the own weight of the circuit component and the distance between a rotation sensor and a sensor magnet is changed. Thus, there is a possibility that the detection accuracy of the rotation sensor is reduced.

### SUMMARY OF THE INVENTION

In view of the above problem, it is an object of one embodiment of the present invention to provide a ceiling fan motor having a structure capable of suppressing reduction of the detection accuracy of a rotation sensor, and a ceiling fan provided with the ceiling fan motor.

In accordance with a first aspect of the present invention, there is provided a ceiling fan motor, including:

a shaft centered at a center axis extending in an up-down direction; a stator fixed to the shaft; an upper motor cover having a tubular portion which surrounds the stator in a circumferential direction; a bearing unit including at least one bearing member which rotatably supports the upper motor cover with respect to the shaft; a lower motor cover attached to a lower portion of the upper motor cover; a rotor magnet fixed to an inner surface of the tubular portion; and a circuit board arranged below the stator, wherein the upper motor cover is a ferromagnetic body, the circuit board includes a board body having a board surface which intersects the up-down direction, a rotation sensor attached to the board body and opposed to the rotor magnet in the up-down direction and a circuit component larger in mass than the rotation sensor, and if there is defined an imaginary line which is orthogonal, when seen in the up-down direction, to a line interconnecting the rotation sensor and the center axis and which passes through the shaft, a gravity center of the circuit board is positioned in one of two areas of the circuit board divided by the imaginary line, which differs from the other area where the rotation sensor exists.

In accordance with a second aspect of the present invention, there is provided a ceiling fan motor, including:

a shaft centered at a center axis extending in an up-down direction; a stator fixed to the shaft; an upper motor cover having a tubular portion which surrounds the stator in a circumferential direction; a bearing unit including at least one bearing member which rotatably supports the upper motor cover with respect to the shaft; a lower motor cover attached to a lower portion of the upper motor cover; a rotor magnet fixed to an inner surface of the tubular portion; and a circuit board arranged below the stator, wherein the stator includes a stator core, an insulator arranged to cover at least a portion of a lower surface of the stator core and a coil wound around the stator core with the insulator interposed therebetween, the upper motor cover is a ferromagnetic body, the circuit board includes a board body having a board surface which intersects the up-down direction, a rotation sensor attached to the board body and opposed to the rotor magnet in the up-down direction and a circuit component larger in mass than the rotation sensor, if there is defined an imaginary line which is orthogonal, when seen in the up-down direction, to a line interconnecting the rotation sensor and the center axis and which passes through the shaft, a gravity center of the circuit board is positioned in one of two areas of the circuit board divided by the imaginary line, where the rotation sensor exists, the circuit board is fixed to the insulator, and a position where the circuit board is fixed to the insulator includes a position located radially outward of a midpoint between an outer edge of the circuit board and the center axis in a radial direction.

According to one embodiment of the present invention, it is possible to provide a ceiling fan motor having a structure capable of suppressing reduction of the detection accuracy of a rotation sensor, and a ceiling fan provided with the ceiling fan motor.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view showing a ceiling fan according to the present preferred embodiment.

FIG. 2 is a sectional view showing a ceiling fan motor according to the present preferred embodiment.

FIG. 3 is a perspective view showing a circuit board and a lower insulator according to the present preferred embodiment.

FIG. 4 is a bottom view showing the circuit board and the lower insulator according to the present preferred embodiment.

FIG. 5 is a bottom view showing an insulator according to the present preferred embodiment.

FIG. 6 is a sectional view showing another example of the ceiling fan motor according to the present preferred embodiment.

FIG. 7 is a sectional view showing a further example of the ceiling fan motor according to the present preferred embodiment.

FIG. 8 is a bottom view showing another example of the circuit board and the lower insulator according to the present preferred embodiment.

### DETAILED DESCRIPTION OF THE PREFERRED EMBODIMENTS

A ceiling fan motor and a ceiling fan according to one preferred embodiment of the present invention will now be described with reference to the accompanying drawings. The scope of the present invention is not limited to the embodiment described below but may be arbitrarily modified without departing from the technical concept of the present invention. In the drawings described below, for the sake of making individual configurations easily understandable, individual structures are sometimes shown in the scale and number different from those of actual structures.

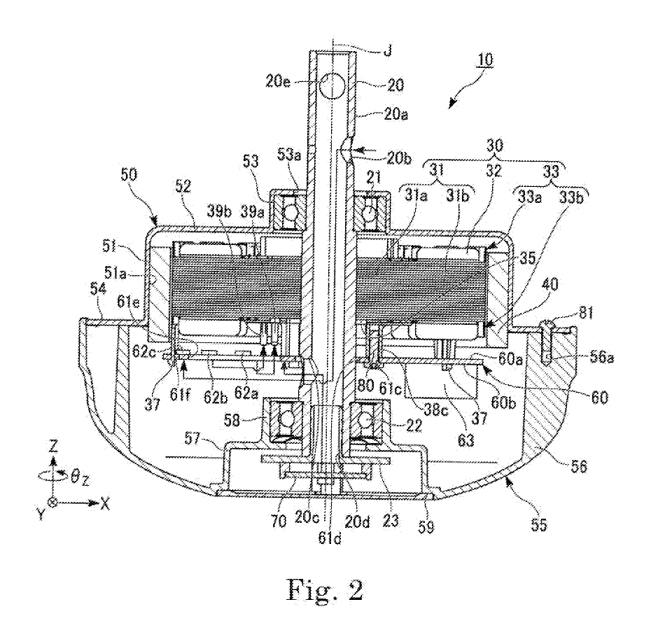

Furthermore, in the drawings, an XYZ coordinate system is appropriately shown as a three-dimensional rectangular coordinate system. In the XYZ coordinate system, the Z-axis direction is an up-down direction. The X-axis direction is a left-right direction in FIG. 2, which is orthogonal to the Z-axis direction. The Y-axis direction is a direction orthogonal to both the X-axis direction and the Z-axis direction.

In the following description, unless specifically mentioned otherwise, the radius direction about a center axis J extending in the up-down direction (the Z-axis direction) will be simply referred to as “radial direction or “radial”. The circumference direction about the center axis J, namely the circumference of the center axis J (the θ(direction), will be simply referred to as “, will be simply referred or” or ill be simply. The up-down direction (Z-axis direction) corresponds to an axial direction of the center axis J.

In the subject specification, the wording “extending in the up-down direction” includes not only a case where something extends strictly in the up-down direction (the Z-axis direction) but also a case where something extend in a direction inclined at an angle of less than 45 degrees with respect to the up-down direction. In the subject specification, the wording “extending in the radial direction i includes not only extending strictly in the radial direction, i.e., the direction perpendicular to the up-down direction (the Z-axis direction) but also extending in a direction inclined at an angle of less than 45 degrees with respect to the radial direction.

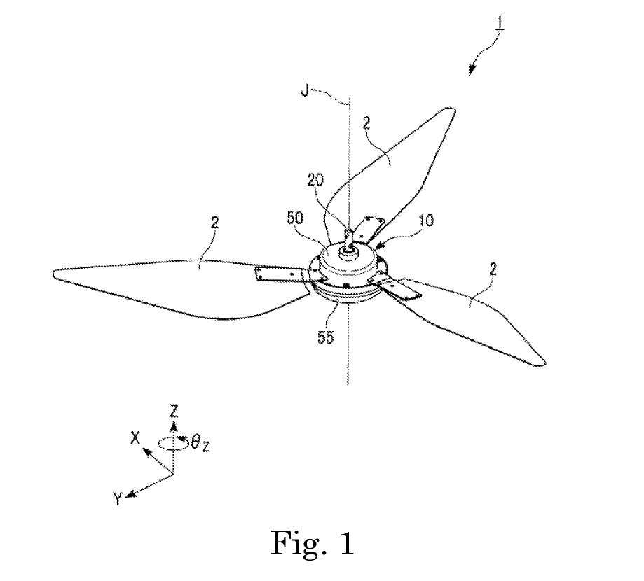

FIG. 1 is a perspective view showing a ceiling fan 1 according to the present preferred embodiment. As shown in FIG. 1, the ceiling fan 1 according to the present preferred embodiment preferably includes a ceiling fan motor 10 and a plurality of moving blades 2 attached to the ceiling fan motor 10. The ceiling fan 1 is installed in, e.g., a ceiling.

### Moving Blade

The moving blades 2 are attached to a below-mentioned upper motor cover 50 of the ceiling fan motor 10. The moving blades 2 are provided at a regular interval in the circumferential direction. In the example shown in FIG. 1, there are provided, e.g., three moving blades 2.

### Ceiling Fan Motor

FIG. 2 is a sectional view showing the ceiling fan motor 10 according to the present preferred embodiment. As shown in FIG. 2, the ceiling fan motor 10 preferably includes a shaft 20, a stator 30, an upper motor cover 50, a bearing unit, a lower motor cover 55, a rotor magnet 40, a circuit board 60 and a sensor substrate 70. In the present preferred embodiment, the bearing unit preferably includes an upper bearing member (or a bearing member) 21 and a lower bearing member (or a bearing member) 22.

The shaft 20 is concentric with the center axis J extending in the up-down direction (the Z-axis direction). The upper (Z-axis plus side) end portion of the shaft 20 is fixed to an attachment portion (not shown) fixed to, e.g., a ceiling. The stator 30 is fixed to the shaft 20. The upper motor cover 50 is rotatably supported by the shaft 20 with an upper bearing member 21 interposed therebetween. The rotor magnet 40 is fixed to the inner surface of the upper motor cover 50. The rotor magnet 40 surrounds the stator 30 about the center axis J (in the θi direction). The lower motor cover 55 is attached to a lower portion of the upper motor cover 50. The circuit board 60 is provided at the lower side (in the Z-axis direction) of the stator 30. The circuit board 60 is accommodated radially inward of the lower motor cover 55. The sensor substrate 70 is provided at the lower side of the shaft 20. The respective parts will now be described in detail.

### Shaft

In the present preferred embodiment, the shaft 20 is a hollow shaft extending in the up-down direction (the Z-axis direction). The shaft 20 is opened toward the upper side (the Z-axis plus side) and the lower side (the Z-axis minus side). An attachment hole 20e radially penetrating the shaft 20 is defined in the upper end portion of the shaft 20. The shaft 20 is fixed through the attachment hole 20e to an attachment portion (not shown) fixed to a ceiling or the like. In the present preferred embodiment, the shaft 20 extends upward beyond the upper motor cover 50. The shaft 20 extends downward beyond the circuit board 60. Alternatively, the lower end of the shaft 20 may be positioned axially above the circuit board 60.

An upper wiring line hole portion 20b communicating with the inside of the shaft 20 is defined in the region of the outer circumferential surface 20a of the shaft 20 positioned at the upper side (the Z-axis plus side) of the upper motor cover 50. A lower wiring line hole portion (or a hole portion) 20c communicating with the inside of the shaft 20 is defined in the region of the outer circumferential surface 20a of the shaft 20 positioned at the lower side (the Z-axis minus side) of the circuit board 60.

### Stator

The stator 30 preferably includes a stator core 31, coils 32 and an insulator 33. The stator core 31 preferably includes a core back portion 31a and teeth portions 31b.

The core back portion 31a has a cylindrical shape concentric with the center axis J. The core back portion 31a is fitted to the shaft 20. The teeth portions 31b extends radially outward from the outer surface of the core back portion 31a. The teeth portions 31b are provided in a plural number and are arranged at a regular interval along the circumferential direction of the outer surface of the core back portion 31a.

The coils 32 are formed by winding conductive wires. The coils 32 are wound around the stator core 31 with the insulator 33 interposed therebetween. Coil wires that constitute the coils 32 are connected to the circuit board 60 through the projection portions 39a, 39b and 39c of a below-described lower insulator 33b.

The insulator 33 preferably includes an upper insulator 33a provided at the upper side (the Z-axis plus side) of the stator core 31 and a lower insulator 33b provided at the lower side (the Z-axis minus side) of the stator core 31. The lower insulator 33b covers at least a portion of the lower surface of the stator core 31. The insulator 33 is made of, e.g., a resin.

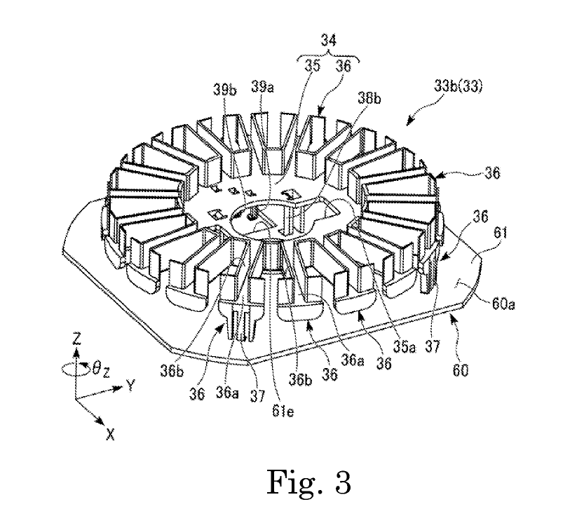

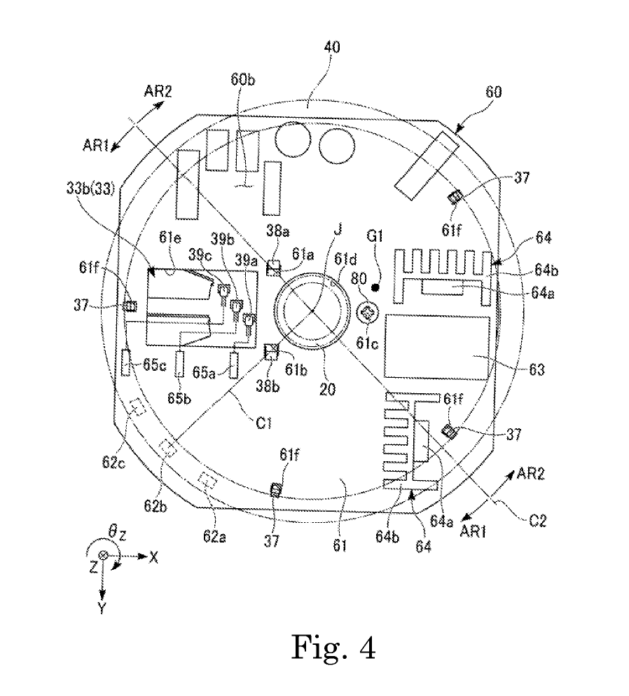

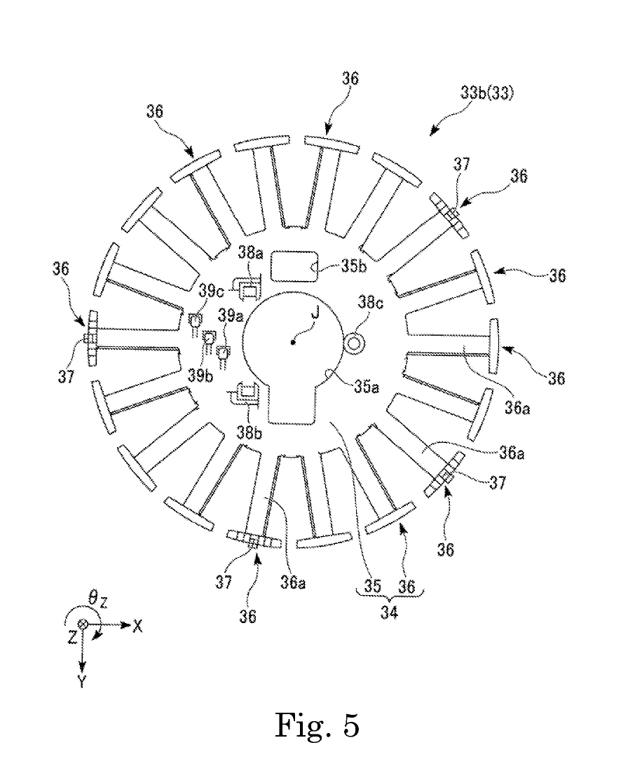

FIGS. 3 and 4 are views showing the circuit board 60 and the lower insulator 33b. FIG. 3 is a perspective view. FIG. 4 is a bottom view, namely a view seen from the lower side (the Z-axis minus side) toward the upper side (the Z-axis plus side). FIG. 5 is a bottom view showing the lower insulator 33b.

As shown in FIGS. 3 and 5, the lower insulator 33b preferably includes an insulator body potion 34, inner claw portions 38a and 38b, a screw fixing portion 38c, outer claw portions (or claw portions) 37 and projection portions 39a, 39b and 39c. That is to say, the insulator 33 preferably includes an insulator body potion 34, inner claw portions 38a and 38b, a screw fixing portion 38c, outer claw portions 37 and projection portions 39a, 39b and 39c.

As shown in FIG. 2, the insulator body potion 34 is fixed to the lower side (the Z-axis minus side) of the stator core 31. As illustrated in FIGS. 3 and 5, the insulator body potion 34 preferably includes a disc portion 35 and protrusion cover portions 36.

The disc portion 35 is a portion that covers at least a portion of the lower side (the Z-axis minus side) of the core back portion 31a. As shown in FIG. 5, the disc portion 35 is concentric with the center axis J. Through-hole portions 35a and 35b are defined in the disc portion 35. The shape of the through-hole portion 35a seen in a bottom view (in an X-Y plane view) is such a shape that a rectangle is joined to a circle concentric with the center axis J. The shape of the through-hole portion 35b seen in a bottom view is, e.g., a rectangular shape. When seen in a bottom view, the through-hole portion 35b is defined at the opposite side (the Y-axis minus side) of the center axis J from the rectangular section of the through-hole portion 35a.

The protrusion cover portions 36 extend radially outward from the outer edge of the disc portion 35. The protrusion cover portions 36 are provided in a plural number and are arranged at a regular interval along the circumferential direction of the outer edge of the disc portion 35. The protrusion cover portions 36 are provided in the same number as the teeth portions 31b.

As shown in FIG. 3, each of the protrusion cover portions 36 preferably includes a bottom plate portion 36a and side plate portions 36b. The plate surfaces of the bottom plate portion 36a are orthogonal to the up-down direction (the Z-axis direction). The bottom plate portion 36a covers the lower side (the Z-axis minus side) of each of the teeth portions 31b.

The side plate portions 36b extend from the circumferential opposite ends of the bottom plate portion 36a toward the upper side (the Z-axis plus side). The side plate portions 36b cover some portions of the circumferential opposite surfaces of each of the teeth portions 31b. Each of the teeth portions 31b is arranged in the region surrounded by the bottom plate portion 36a and the side plate portions 36b of each of the protrusion cover portions 36.

An inner claw portion 38b protrudes from the disc portion 35 toward the lower side (the Z-axis minus side). A claw is formed at the distal end of the inner claw portion 38b. This holds true in case of an inner claw portion 38a. As shown in FIG. 2, the screw fixing portion 38c protrudes downward from the disc portion 35. The screw fixing portion 38c has, e.g., a cylindrical shape. A female thread is formed on the inner surface of the screw fixing portion 38c.

As shown in FIG. 5, the outer claw portions 37 are provided in a plural number. In the present preferred embodiment, there are provided, e.g., four outer claw portions 37. As illustrated in FIG. 3, the outer claw portions 37 protrude toward the lower side (the Z-axis minus side) from the radial outer end portions of some of the protrusion cover portions 36. That is to say, the outer claw portions 37 protrude downward from the insulator body potion 34. In the example shown in FIG. 5, the protrusion cover portions 36 not provided with the outer claw portions 37 are positioned in the circumferential gap between the protrusion cover portions 36 provided with the outer claw portions 37. The number and position of the outer claw portions 37 are decided depending on, e.g., the gravity center G1 of the circuit board 60 to be described later.

As shown in FIGS. 2 and 3, the projection portions 39a and 39b protrude from the disc portion 35 toward the lower side (the Z-axis minus side). That is to say, the projection portions 39a and 39b protrude downward from the insulator body potion 34. This holds true in case of the projection portion 39c. As shown in FIG. 4, when seen in the up-down direction (the Z-axis direction), the projection portions 39a, 39b and 39c are provided at the positions where the projection portions 39a, 39b and 39c overlap with an area AR1 of the circuit board 60.

The coil wires that constitute the coils 32 are hung over the projection portions 39a, 39b and 39c. The coil wires hung over the projection portions 39a, 39b and 39c extend downward from the upper side (the Z-axis plus side) of the circuit board 60 through a stator wiring line through-hole portion 61e of the circuit board 60 to be described later.

In the present preferred embodiment, the lower insulator 33b is a one-piece member. That is to say, in the present preferred embodiment, the insulator body potion 34, the inner claw portions 38a and 38b, the screw fixing portion 38c, the outer claw portions 37 and the projection portions 39a, 39b and 39c are a one-piece member. The lower insulator 33b is manufactured by, e.g., injection molding.

The upper insulator 33a shown in FIG. 2 is arranged upside down with respect to the lower insulator 33b. The upper insulator 33a covers the upper side (the Z-axis plus side) of the teeth portions 31b of the stator core 31 and some portions of the circumferential opposite end surfaces of the teeth portions 31b. Other configurations of the upper insulator 33a are the same as the configurations of the insulator body potion 34 of the lower insulator 33b.

The entire circumferential opposite end surfaces of the teeth portions 31b are covered with the lower insulator 33b and the upper insulator 33a. Thus, the circumferences of the teeth portions 31b extending in the protruding direction of the teeth portions 31b, i.e., in the radial direction, are fully surrounded by the insulator 33. The coils 32 are wound around the teeth portions 31b with the insulator 33 interposed therebetween.

### Upper Motor Cover

As shown in FIG. 2, the upper motor cover 50 is a cover that covers the stator 30 at the upper side (the Z-axis plus side) thereof. The upper motor cover 50 is a ferromagnetic body. The material of the upper motor cover 50 is not particularly limited as along as it has a ferromagnetic property. Examples of the material of the upper motor cover 50 include iron, cobalt and nickel. The upper motor cover 50 serves as a rotor yoke.

The upper motor cover 50 preferably includes a tubular portion 51, a top plate portion 52, an upper bearing member holding portion 53 and a flange portion 54. The upper motor cover 50 is supported to rotate about the center axis J (in the ±θθ direction) with respect to the shaft 20 in a state in which the upper bearing member 21 held by the upper bearing member holding portion 53 is interposed between the upper motor cover 50 and the shaft 20.

The tubular portion 51 is formed into a tubular shape so as to fully surround the stator 30 in the circumferential direction. In the present preferred embodiment, the tubular portion 51 has, e.g., a cylindrical shape. The rotor magnet 40 is fixed to an inner surface 51a of the tubular portion 51. The top plate portion 52 is arranged at the upper side (the Z-axis plus side) of the tubular portion 51. A central section of the top plate portion 52 protrudes upward.

The upper bearing member holding portion 53 is configured by the central section of the top plate portion 52 protruding upward. The upper bearing member 21 is held radially inward of the upper bearing member holding portion 53. That is to say, the upper bearing member 21 is fixed to the upper motor cover 50. The upper bearing member 21 is disposed above the stator 30. A through-hole portion 53a concentric with the center axis J is defined in the upper bearing member holding portion 53. The shaft 20 is exposed out of the upper motor cover 50 through the through-hole portion 53a.

The flange portion 54 extends radially outward from a lower end of the tubular portion 51. The upper motor cover 50 is fixed to the lower motor cover 55 in the flange portion 54.

### Rotor Magnet

The rotor magnet 40 is fixed to the inner surface of the tubular portion 51 of the upper motor cover 50. In the present preferred embodiment, as shown in FIG. 4, the rotor magnet 40 has, e.g., an annular shape. As illustrated in FIG. 2, the rotor magnet 40 fully surrounds the stator 30 in the circumferential direction. The lower end of the rotor magnet 40 is positioned axially below the tubular portion 51 of the upper motor cover 50. In other words, the lower end of the tubular portion 51 of the upper motor cover 50 is positioned at the upper side (the Z-axis plus side) of the lower end of the rotor magnet 40.

### Lower Motor Cover

The lower motor cover 55 preferably includes a lower motor cover body 56, a sensor substrate accommodating portion 57 and a lower bearing member holding portion 58. The lower motor cover 55 covers the stator 30 and the circuit board 60 at the lower side (the Z-axis minus side).

In the present preferred embodiment, the lower motor cover 55 is, e.g., a one-piece member. The lower motor cover 55 is made of, e.g., metal. The lower motor cover 55 is rotatably supported to rotate about the center axis J (in the ±θθ direction) with respect to the shaft 20 in a state in which the lower bearing member 22 held by the lower bearing member holding portion 58 is interposed between the lower motor cover 55 and the shaft 20.

Female thread portions 56a are formed on an upper (the Z-axis plus side) surface of the lower motor cover body 56. While not shown in the drawings, the female thread portions 56a are formed in a plural number at a regular interval along the circumferential direction. Male threads 81 are tightened to the female thread portions 56a with the flange portion 54 of the upper motor cover 50 interposed therebetween. Thus, the lower motor cover body 56 is fixed to the upper motor cover 50.

The sensor substrate accommodating portion 57 is formed by depressing the central portion of the lower motor cover body 56 toward the upper side (the Z-axis plus side). The sensor substrate is accommodated radially inward of the sensor substrate accommodating portion 57. A sensor substrate cover 59 is provided at the opening side (the Z-axis minus side) of the sensor substrate accommodating portion 5. The sensor substrate cover 59 is arranged to close the opening of the sensor substrate accommodating portion 57. The sensor substrate cover 59 is made of, e.g., a resin.

The lower bearing member holding portion 58 is provided at the upper side (the Z-axis plus side) of the sensor substrate accommodating portion 57. The lower bearing member holding portion 58 is positioned at the lower side (the Z-axis minus side) of the circuit board 60. The lower bearing member 22 is held radially inward of the lower bearing member holding portion 58. That is to say, the lower bearing member 22 is fixed to the lower motor cover 55 at the lower side of the circuit board 60. The lower bearing member 22 is disposed axially below the stator 30.

### Circuit Board

As shown in FIG. 4, the circuit board 60 preferably includes a board body 61, rotation sensors 62a, 62b and 62c, a capacitor (a circuit component) 63, an inverter (a circuit component) 64 and coil connection terminals 65a, 65b and 65c.

The shape of the board body 61 seen in a bottom view (in a X-Y plane view) is, e.g., a rectangular shape with four corners cut into an arc shape. As shown in FIG. 2, board surfaces of the board body 61, namely a circuit board upper surface 60a and a circuit board lower surface 60b, intersect the up-down direction (the Z-axis direction). In the present preferred embodiment, the board surfaces of the circuit board 60 are orthogonal to the up-down direction.

As shown in FIGS. 2 and 4, a shaft through-hole portion 61d extending through the board body 61 in the thickness direction (the Z-axis direction) is defined at the center of the board body 61. The shaft through-hole portion 61d is concentric with the center axis J. A portion of the shaft 20 is inserted into the shaft through-hole portion 61d.

A stator wiring line through-hole portion 61e extending through the board body 61 in the thickness direction (the Z-axis direction) is defined in the board body 61. The bottom-view shape of the stator wiring line through-hole portion 61e is not particularly limited and is, e.g., a rectangular shape in the example shown in FIG. 4. The stator wiring line through-hole portion 61e is defined at the position overlapping with the projection portions 39a, 39b and 39c of the lower insulator 33b when seen in the up-down direction (the Z-axis direction) in a state in which the circuit board 60 is attached to the lower insulator 33b.

Fixing through-hole portions 61a, 61b, 61c and 61f extending through the board body 61 in the thickness direction (the Z-axis direction) are defined in the board body 61. A portion of the inner claw portion 38a of the lower insulator 33b is inserted into the fixing through-hole portion 61a. The distal end of the inner claw portion 38a passes through the fixing through-hole portion 61a and is hooked to the circuit board lower surface 60b of the circuit board 60. The board body 61, namely the circuit board 60, is fixed to the inner claw portion 38a by snap fit. A portion of the inner claw portion 38b of the lower insulator 33b is inserted into the fixing through-hole portion 61b. The circuit board 60 is fixed to the inner claw portion 38b by snap fit.

As shown in FIG. 2, a male thread 80 is partially inserted into the fixing through-hole portion 61c. The male thread 80 is inserted through the fixing through-hole portion 61c from the lower side (the Z-axis minus side) of the circuit board 60 and is tightened to the female thread of the screw fixing portion 38c of the lower insulator 33b. Thus, the circuit board 60 is fixed to the screw fixing portion 38c.

As shown in FIG. 4, the fixing through-hole portions 61a, 61b and 61c are positioned radially inward of the midpoint between the outer edge of the circuit board 60 and the center axis J in the radial direction. That is to say, the positions where the circuit board 60 is fixed to the insulator 33 by the inner claw portions 38a and 38b and the screw fixing portion 38c are located radially inward of the midpoint between the outer edge of the circuit board 60 and the center axis J in the radial direction.

More specifically, in the present preferred embodiment, the fixing through-hole portions 61a, 61b and 61c are positioned radially inward of the gravity center G1 of the circuit board 60 in the radial direction. That is to say, the positions where the circuit board 60 is fixed to the insulator 33 by the inner claw portions 38a and 38b and the screw fixing portion 38c are located radially inward of the gravity center G1 of the circuit board 60 in the radial direction.

As shown in FIG. 2, the outer claw portions 37 of the lower insulator 33b are partially inserted into the fixing through-hole portions 61f. The distal ends of the outer claw portions 37 pass through the fixing through-hole portions 61f and are hooked to the circuit board lower surface 60b of the circuit board 60. The board body 61, namely the circuit board 60, is fixed to the outer claw portions 37 by snap fit. As shown in FIG. 4, the fixing through-hole portions 61f are provided in the same number as the number of the outer claw portions 37. That is to say, in the present preferred embodiment, there are provided, e.g., four fixing through-hole portions 61f.

The fixing through-hole portions 61f are positioned radially outward of the midpoint between the outer edge of the circuit board 60 and the center axis J in the radial direction. That is to say, the positions where the circuit board 60 is fixed to the insulator 33 by the outer claw portions 37 are located radially outward of the midpoint between the outer edge of the circuit board 60 and the center axis J in the radial direction. In other words, the positions where the circuit board 60 is fixed to the insulator include the positions located radially outward of the midpoint between the outer edge of the circuit board 60 and the center axis J in the radial direction.

More specifically, in the present preferred embodiment, the positions of the fixing through-hole portions 61f are located radially outward of the gravity center G1 of the circuit board 60. That is to say, the positions where the circuit board 60 is fixed to the insulator by the outer claw portions 37 are located radially outward of the gravity center G1 of the circuit board 60.

In the aforementioned manner, the board body 61, namely the circuit board 60, is fixed to the inner claw portions 38a and 38b, the screw fixing portion 38c and the outer claw portions 37 of the lower insulator 33b. Thus, the circuit board 60 is fixed to the lower insulator 33b, i.e., the insulator 33.

Wiring lines for electrically interconnecting the circuit board 60 and an external power source (not shown) are connected to the board body 61. As shown in FIG. 2, the wiring lines interconnecting the circuit board 60 and the external power source pass through the upper wiring line hole portion 20b, the inside of the shaft 20 and the lower wiring line hole portion 20c and extend into the lower motor cover 55. Then, the wiring lines extending from the external power source are connected to the board body 61 of the circuit board 60.

As shown in FIGS. 2 and 4, the rotation sensors 62a, 62b and 62c are attached to the board body 61. The rotation sensors 62a, 62b and 62c are provided on the upper surface 60a of the circuit board 60. As shown in FIG. 4, the rotation sensors 62a, 62b and 62c are provided at the positions overlapping with the rotor magnet 40 in the up-down direction (the Z-axis direction). That is to say, the rotation sensors 62a, 62b and 62c are opposed to the rotor magnet 40 in the up-down direction. The rotation sensors 62a, 62b and 62c are arranged side by side along the circumferential direction. In the present preferred embodiment, for example, the circumferential distance between the rotation sensors 62a and 62b is equal to the circumferential distance between the rotation sensors 62b and 62c. The rotation sensors 62a, 62b and 62c are, e.g., Hall elements.

A capacitor 63 and an inverter 64 are attached to the board body 61. The capacitor 63 and the inverter 64 are provided on the circuit board lower surface 60b of the circuit board 60. The capacitor 63 and the inverter 64 are circuit components larger in mass than the rotation sensors 62a, 62b and 62c. The inverter 64 preferably includes an inverter element 64a and a heat sink 64b attached to the inverter element 64a.

In the example shown in FIG. 4, a plurality of circuit components other than the capacitor 63 and the inverter 64 is additionally attached to the board body 61. Other circuit components may be larger or smaller in mass than the rotation sensors 62a, 62b and 62c.

The coil connection terminals 65a, 65b and 65c are provided on the circuit board lower surface 60b of the circuit board 60. A coil wire hung over the projection portion 39a is connected to the coil connection terminal 65a. A coil wire hung over the projection portion 39b is connected to the coil connection terminal 65b. A coil wire hung over the projection portion 39c is connected to the coil connection terminal 65c. A drive current corresponding to the information on the position of the rotor magnet 40 detected by the rotation sensors 62a, 62b and 62c is supplied to the stator 30 via the coil connection terminals 65a, 65b and 65c.

In the subject specification, the circuit board 60 is divided into two areas AR1 and AR2 by an imaginary line C2 shown in FIG. 4. The imaginary line C2 is a line which is orthogonal, when seen in the up-down direction (the Z-axis direction), to a line C1 interconnecting the rotation sensors 62a, 62b and 62c and the center axis J and which passes through the shaft 20. In the present preferred embodiment, the imaginary line C2 is a line passing through the center axis J. If the imaginary line C2 is defined as above, the gravity center G1 of the circuit board 60 is positioned in one of the two areas AR1 and AR2, namely in the area AR2 which differs from the area AR1 where the rotation sensors 62a, 62b and 62c exists. In the present preferred embodiment, the shaft 20 penetrates the circuit board 60 in the axial direction. However, the shaft 20 need not necessarily penetrate the circuit board 60 in the axial direction. The axial lower end of the shaft 20 may be positioned axially above the circuit board 60. In this case, it is only necessary that the imaginary line C2 be a line which is orthogonal, when seen in the up-down direction (the Z-axis direction), to the line C1 interconnecting the rotation sensors 62a, 62b and 62c and the center axis J and which passes through a region overlapping with the circuit board 60 when the shaft 20 is projected in the up-down direction.

In the subject specification, the wording “line interconnecting the rotation sensors and the center axis Ji includes a line which, if there exists a plurality of rotation sensors, interconnects the circumferential midpoint of a region where the plurality of rotation sensors exists and the center axis J. In the example shown in FIG. 4, the rotation sensor 62b is disposed at the circumferential midpoint between the rotation sensors 62a and 62c. Thus, the line C1 interconnecting the rotation sensors and the center axis J is a line which interconnects a circumferential center of the rotation sensor 62b and the center axis J.

Furthermore, in the subject specification, the wording “line interconnecting the rotation sensors and the center axis Jn includes a line which, if there exists a single rotation sensor, interconnects the circumferential center of the rotation sensor and the center axis J.

### Sensor Substrate

As shown in FIG. 2, the sensor substrate 70 is arranged at the lower side (the Z-axis minus side) of the shaft 20 within the sensor substrate accommodating portion 57. More specifically, the sensor substrate 70 is held by a sensor substrate holding member 23 fixed to the shaft 20. The sensor substrate holding member 23 has a tubular shape opened at the opposite sides in the up-down direction (the Z-axis direction). A portion of the sensor substrate holding member 23 is inserted into the shaft 20 from the lower opening 20d of the shaft 20. Thus, the sensor substrate holding member 23 is fixed to the shaft 20.

The sensor substrate 70 is electrically connected to the circuit board 60 by a wiring line. The wiring line interconnecting the sensor substrate 70 and the circuit board 60 extends from the inside of the sensor substrate accommodating portion 57 into the lower motor cover 55 through the inside of the sensor substrate holding member 23, the inside of the shaft 20 and the lower wiring line hole portion 20c.

The sensor substrate 70 is manipulated by a user through the use of, e.g., a remote controller. In response to the user's manipulation, the sensor substrate 70 transmits a signal to the circuit board 60.

In the present preferred embodiment, the circuit board 60 is connected to an external power source (not shown) by a wiring line extending through the upper wiring line hole portion 20b and the lower wiring line hole portion 20c of the shaft 20. Responsive to the manipulation of the sensor substrate 70 and the signals of the rotation sensors 62a, 62b and 62c, the circuit board 60 supplies a drive current to the coils 32 of the stator 30. If the drive current is supplied to the coils 32, magnetic fields are generated. The rotor magnet 40 is rotated about the center axis J (in the ±θθ direction) by the magnetic fields. Thus, the upper motor cover 50 and the lower motor cover 55 are rotated about the center axis J. In this way, the ceiling fan motor 10 according to the present preferred embodiment obtains rotary drive power. The moving blades 2 attached to the ceiling fan motor 10 are rotated by the ceiling fan motor 10. As a result, the ceiling fan 1 is rotated.

According to the present preferred embodiment, the circuit board 60 is arranged below the stator 30. It is therefore possible to reduce the up-down-direction dimension of the ceiling fan motor 10. This makes it possible to reduce the up-down-direction dimension of the ceiling fan 1.

According to the present preferred embodiment, the gravity center G1 of the circuit board 60 is located in the area AR2 which differs from the area AR1 where the rotation sensors 62a, 62b and 62c exist. For that reason, the position where the circuit board 60 is deflected by the circuit components such as the capacitor 63 and the inverter 64 larger in mass than the rotation sensors 62a, 62b and 62c is located in the area AR2. This makes it possible to suppress deflection of the circuit board 60 in the area AR1 where the rotation sensors 62a, 62b and 62c exist. Therefore, according to the present preferred embodiment, it is possible to obtain a ceiling fan motor having a structure capable of suppressing reduction of the detection accuracy of the rotation sensors 62a, 62b and 62c, and a ceiling fan provided with the ceiling fan motor.

According to the present preferred embodiment, the upper motor cover 50 is a ferromagnetic body. For that reason, the upper motor cover 50 serves as a rotor yoke. That is to say, the upper motor cover 50 has a function of a housing of the ceiling fan motor 10 and a function of a rotor yoke. Therefore, according to the present preferred embodiment, there is no need to provide a separate rotor yoke. This makes it possible to reduce the number of parts.

According to the present preferred embodiment, the circuit board 60 is fixed to the insulator 33 at the lower side of the stator 30. The fixing position of the circuit board 60 includes a position which is located radially outward of the midpoint between the outer edge of the circuit board 60 and the center axis J. It is therefore possible to restrain the radial outer portion of the circuit board 60 from being deflected downward by the gravity.

According to the present preferred embodiment, the positions where the outer claw portions 37 are fixed to the circuit board 60 are located radially outward of the gravity center G1 of the circuit board 60. It is therefore possible to further restrain the radial outer portion of the circuit board 60 from being deflected.

According to the present preferred embodiment, the outer claw portions 37 are fixed to the circuit board 60 by snap fit. It is therefore possible to easily and strongly fix the circuit board 60 and the outer claw portions 37.

According to the present preferred embodiment, the insulator body potion 34 and the outer claw portions 37 are a one-piece member. Thus, the lower insulator 33b including the insulator body potion 34 and the outer claw portions 37 can be manufactured by, e.g., injection molding. This makes it possible to suppress an increase in the manufacturing cost of the ceiling fan motor 10. This holds true in case of the inner claw portions 38a and 38b and the screw fixing portion 38c.

According to the present preferred embodiment, the circuit board 60 is fixed to the inner claw portions 38a and 38b of the lower insulator 33b by snap fit. The circuit board 60 is fixed to the screw fixing portion 38c of the lower insulator 33b by the male thread 80. The positions where the circuit board 60 is fixed to the inner claw portions 38a and 38b and the screw fixing portion 38c are located radially inward of the midpoint between the outer edge of the circuit board 60 and the center axis J. This makes it possible to fix the central portion of the circuit board 60 to the lower insulator 33b. Therefore, according to the present preferred embodiment, it is possible to stably fix the circuit board 60 to the insulator 33.

According to the present preferred embodiment, the circuit board 60 is fixed to the inner claw portions 38a and 38b and the screw fixing portion 38c. It is therefore possible to prevent the circuit board 60 from falling down.

According to the present preferred embodiment, the coil wires of the coils 32 extends to the circuit board 60 via the projection portions 39a, 39b and 39c provided in the lower insulator 33b. It is therefore possible to prevent the coil wires from making contact with an inner edge of the stator wiring line through-hole portion 61e of the circuit board 60. Therefore, according to the present preferred embodiment, it is possible to prevent the coil wires from being rubbed and disconnected.

According to the present preferred embodiment, when seen in the up-down direction, the projection portions 39a, 39b and 39c are arranged at the positions overlapping with the area AR1 of the circuit board 60, namely the area where the rotation sensors 62a, 62b and 62c exist. It is therefore possible to suppress variation in the up-down-direction distance between the projection portions 39a, 39b and 39c and the coil connection terminals 65a, 65b and 65c, which may otherwise be generated by the deflection of the circuit board 60. This makes it possible to suppress damage of the connection portions between the circuit board 60 and the coil wires of the coils 32. It is therefore possible to prevent the electrical connection between the circuit board 60 and the stator 30 from being broken.

According to the present preferred embodiment, the lower end of the tubular portion 51 of the upper motor cover 50 is positioned axially above the lower end of the rotor magnet 40. For that reason, the magnetic flux emitted from the rotor magnet 40 is easy to flow downward. It is also easy for the rotation sensors 62a, 62b and 62c to detect the magnetic flux of the rotor magnet 40. Therefore, according to the present preferred embodiment, it is possible to enhance the detection accuracy of the position of the rotor magnet 40 detected by the rotation sensors 62a, 62b and 62c.

According to the present preferred embodiment, the shaft 20 is hollow. The shaft 20 extends axially below the circuit board 60. The lower wiring line hole portion 20c communicating with the inside of the shaft 20 is defined in the region of the outer circumferential surface 20a of the shaft 20 positioned axially below the circuit board 60. Thus, the wiring lines connected to the circuit board 60 can be allowed to extend through the inside of the shaft 20. Furthermore, the lower wiring line hole portion 20c is defined below the circuit board 60. Thus, after the circuit board 60 is fixed to the lower insulator 33b, the wiring lines extending from the lower wiring line hole portion 20c into the lower motor cover 55 can be easily connected to the circuit board 60. Therefore, according to the present preferred embodiment, it is possible to improve the efficiency of a work of connecting the wiring lines to the circuit board 60.

According to the present preferred embodiment, the shaft 20 has the lower opening 20d. The sensor substrate 70 is arranged below the shaft 20. Thus, the wiring lines interconnecting the sensor substrate 70 and the circuit board 60 can be allowed to extend into the shaft 20 through the opening 20d.

According to the present preferred embodiment, the circuit board 60 is provided below the stator 30. It is therefore possible to reduce the up-down-direction distance between the circuit board 60 and the sensor substrate 70. This makes it easy to interconnect the circuit board 60 and the sensor substrate 70 with the wiring lines. In addition, it is possible to shorten the length of the wiring lines which interconnect the circuit board 60 and the sensor substrate 70.

According to the present preferred embodiment, the bearing unit includes the upper bearing member 21 and the lower bearing member 22. The upper bearing member 21 is disposed above the stator 30. The lower bearing member 22 is disposed below the stator 30. Thus, the upper motor cover 50 and the lower motor cover 55 are supported at the opposite ends of the shaft 20. Therefore, according to the present preferred embodiment, even if the up-down-direction dimension of the ceiling fan motor 10 is set small, it is possible to suppress reduction in the rotation accuracy of the ceiling fan motor 10.

In the present preferred embodiment, it may be possible to employ the following configurations. In the description made below, the same configurations as described above will be designated by like reference symbols with no description made thereon.

In the present preferred embodiment, the outer claw portions 37 may be members differing from the insulator body potion 34.

In the present preferred embodiment, the method of fixing the circuit board 60 to the insulator 33 is not particularly limited. In the present preferred embodiment, for example, screw fixing portions may be provided in place of the outer claw portions 37. In this case, the circuit board 60 is fixed to the screw fixing portions by tightening male threads to female threads formed on the inner surfaces of the screw fixing portions.

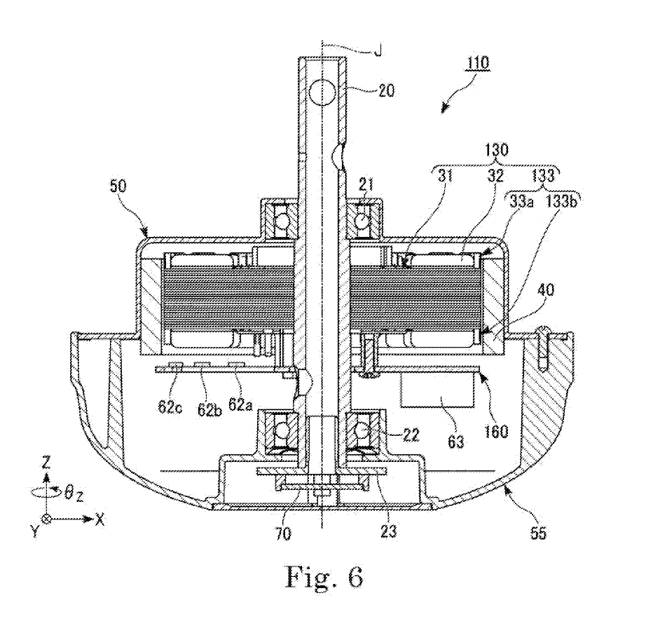

In the present preferred embodiment, it may be possible to employ a configuration shown in FIG. 6. FIG. 6 is a sectional view showing a ceiling fan motor 110 which is another example of the present preferred embodiment.

Referring to FIG. 6, the ceiling fan motor 110 preferably includes a shaft 20, a stator 130, an upper motor cover 50, an upper bearing member 21, a lower bearing member 22, a lower motor cover 55, a rotor magnet 40, a circuit board 160 and a sensor substrate 70.

The stator 130 preferably includes a stator core 31, coils 32 and an insulator 133. The insulator 133 preferably includes an upper insulator 33a and a lower insulator 133b. The lower insulator 133b has the same configuration as the lower insulator 33b shown in FIGS. 3 and 5, except that the lower insulator 133b is not provided with the outer claw portions 37.

The circuit board 160 has the same configuration as the circuit board 60 shown in FIG. 4, except that the circuit board 160 is not provided with the fixing through-hole portions 61f into which the outer claw portions 37 are inserted and fixed. Other configurations of the ceiling fan motor 110 are the same as the configurations of the ceiling fan motor 10 shown in FIGS. 1 to 5.

According to this configuration, just like the ceiling fan motor 10 described above, the gravity center of the circuit board 160 is located in the area AR2 which differs from the area AR1 where the rotation sensors 62a, 62b and 62c exist. It is therefore possible to restrain the circuit board 160 from being deflected downward in the up-down direction. Therefore, according to this configuration, it is possible to obtain a ceiling fan motor having a structure capable of suppressing reduction of the detection accuracy of the rotation sensors 62a, 62b and 62c, and a ceiling fan provided with the ceiling fan motor.

In the present preferred embodiment, the insulator 33 may not be provided with the projection portions 39a, 39b and 39c. In the forgoing description, the insulator 33 is configured to include the upper insulator 33a and the lower insulator 33b as independent members. However, the present invention is not limited thereto. In the present preferred embodiment, the insulator 33 may be a one-piece member.

In the present preferred embodiment, the lower end of the tubular portion 51 of the upper motor cover 50 may be flush with the lower end of the rotor magnet 40 in the up-down direction or may be positioned axially below the lower end of the rotor magnet 40.

In the present preferred embodiment, the shaft 20 may be a solid member. In the present preferred embodiment, the sensor substrate 70 may not be provided. In the present preferred embodiment, the lower end of the shaft 20 may be positioned axially above the circuit board 60.

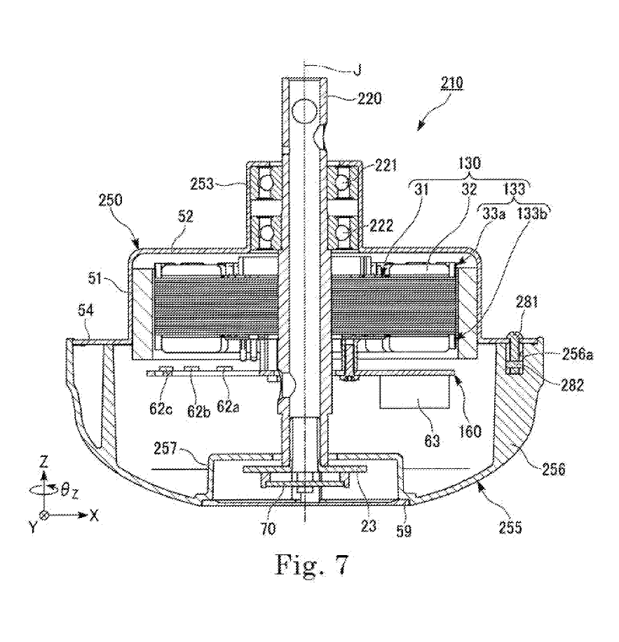

In the present preferred embodiment, it may be possible to employ a configuration shown in FIG. 7. FIG. 7 is a sectional view showing a ceiling fan motor 210 which is a further example of the present preferred embodiment. The ceiling fan motor 210 differs from the aforementioned ceiling fan motor 10 in that an upper motor cover 250 and a lower motor cover 255 are supported on a shaft 220 at one side.

As shown in FIG. 7, the ceiling fan motor 210 preferably includes a shaft 220, a stator 130, an upper motor cover 250, a bearing unit, a lower motor cover 255, a rotor magnet 40, a circuit board 160 and a sensor substrate 70. The bearing unit preferably includes an upper bearing member (or a bearing member) 221 and a lower bearing member (or a bearing member) 222.

The shaft 220 is identical with the shaft 20 shown in FIG. 2. The upper motor cover 250 preferably includes a tubular portion 51, a top plate portion 52, a bearing member holding portion 253 and a flange portion 54.

The bearing member holding portion 253 differs from the upper bearing member holding portion 53 shown in FIG. 2 in that the dimension of the bearing member holding portion 253 in the up-down direction (the Z-axis direction) is larger than the dimension of the upper bearing member holding portion 53. The bearing member holding portion 253 holds the upper bearing member 221 and the lower bearing member 222. The lower bearing member 222 is arranged at the lower side (the Z-axis minus side) of the upper bearing member 221. The upper bearing member 221 and the lower bearing member 222 are positioned at the upper side (the Z-axis plus side) of the stator 130.

The lower motor cover 255 preferably includes a lower motor cover body 256 and a sensor substrate accommodating portion 257. The lower motor cover 255 differs from the lower motor cover 55 shown in FIG. 2 in that the lower motor cover 255 is not provided with the lower bearing member holding portion 58.

Unlike the lower motor cover body 56 shown in FIG. 2, the lower motor cover body 256 is provided with recess portions 256a in place of the female thread portions 56a. Nuts 282 are fixed within the recess portions 256a. That is to say, the nuts 282 are fixed to the lower motor cover 255. A method of fixing the nuts 282 is not particularly limited. For example, the nuts 282 may be fixed within the recess portions 256a by press fit or may be fixed within the recess portions 256a by an adhesive agent. The upper motor cover 250 and the lower motor cover 255 are fixed to each other by tightening bolts 281 to the nuts 282 with the upper motor cover 250 interposed therebetween.

The lower motor cover 255 is made of, e.g., a resin. Other configurations of the ceiling fan motor 210 are the same as the configurations of the ceiling fan motor 10 shown in FIGS. 1 to 5.

According to this configuration, no bearing member is provided between the circuit board 160 and the sensor substrate 70 in the up-down direction. It is therefore possible to further reduce the up-down-direction distance between the circuit board 160 and the sensor substrate 70. Therefore, according to the present preferred embodiment, it is possible to further reduce the up-down-direction dimension of the ceiling fan motor 210. Moreover, according to this configuration, it is possible to easily interconnect the circuit board 160 and the sensor substrate 70.

Furthermore, according to this configuration, the lower motor cover 255 is a one-piece member made of a resin. Thus, the lower motor cover 255 can be manufactured by, e.g., injection molding. This makes it possible to reduce the manufacturing cost of the ceiling fan motor 210.

If the lower motor cover 255 is made of a resin, there is a possibility that the upper motor cover 250 and the lower motor cover 255 cannot be stably fixed to each other by a method of directly forming female thread portions in the lower motor cover body 256 and tightening male threads to the female thread portions.

In contrast, according to this configuration, the upper motor cover 250 and the lower motor cover 255 are fixed to each other by tightening the bolts 281 to the nuts 282 fixed to the lower motor cover 255. Accordingly, it is possible to strongly fix the upper motor cover 250 and the lower motor cover 255 to each other.

In this configuration, the bearing unit may be configured to include only one bearing member. That is to say, in the present preferred embodiment, it may be possible to employ a configuration in which the bearing unit includes at least one bearing member.

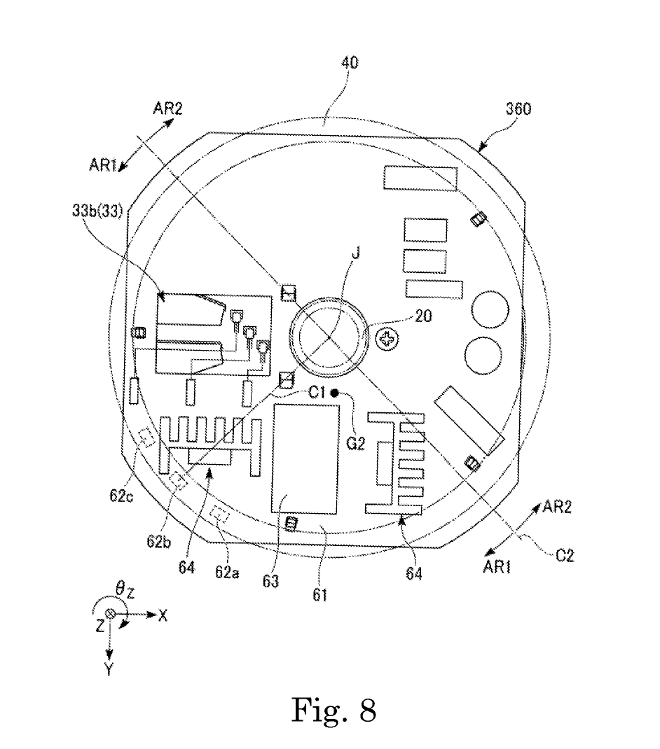

In the present preferred embodiment, it may be possible to employ a configuration shown in FIG. 8. FIG. 8 is a bottom view showing a circuit board 360 and a lower insulator 33b according to a still further example of the present preferred embodiment.

The circuit board 360 differs in the position of the gravity center G2 from the circuit board 60 shown in FIG. 4. The circuit board 360 differs from the circuit board 60 in terms of the arrangement of the circuit components including the capacitor 63 and the inverter 64 on the board body 61. Thus, as shown in FIG. 8, the gravity center G2 of the circuit board 360 is positioned in one of two areas AR1 and AR2 of the circuit board 360 divided by an imaginary line C2, which is the same area AR1 as the area AR1 where the rotation sensors 62a, 62b and 62c exist. Other configurations of the circuit board 360 are the same as the configurations of the circuit board 60 shown in FIG. 4.

With this configuration, just like the circuit board 60 shown in FIG. 4, the circuit board 360 is fixed to the insulator 33. The fixing positions of the circuit board 360 include a position located radially outward of the midpoint between the outer edge of the circuit board 360 and the center axis J in the radial direction. It is therefore possible to restrain the radial outward portion of the circuit board 360 from being deflected downward by the gravity.

In the foregoing description, the imaginary line C2 is a line that passes through the center axis J. However, the imaginary line C2 is not limited thereto. In the present preferred embodiment, the imaginary line C2 may not pass through the center axis J as long as it is orthogonal to the line C1 and passes through the shaft 20.

The respective configurations described above may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A ceiling fan motor, comprising:
a shaft centered at a center axis extending in an up-down direction;
a stator fixed to the shaft;
an upper motor cover having a tubular portion which surrounds the stator in a circumferential direction;
a bearing unit including at least one bearing member which rotatably supports the upper motor cover with respect to the shaft;
a lower motor cover attached to a lower portion of the upper motor cover;
a rotor magnet fixed to an inner surface of the tubular portion; and
a circuit board arranged below the stator,
wherein the upper motor cover is a ferromagnetic body,
the circuit board includes a board body having a board surface which intersects the up-down direction, a rotation sensor attached to the board body and opposed to the rotor magnet in the up-down direction and a circuit component larger in mass than the rotation sensor, and
if there is defined an imaginary line which is orthogonal, when seen in the up-down direction, to a line interconnecting the rotation sensor and the center axis and which passes through the shaft, a gravity center of the circuit board is positioned in one of two areas of the circuit board divided by the imaginary line, which differs from the other area where the rotation sensor exists.

2. The motor according to claim 1, wherein the stator includes a stator core, an insulator arranged to cover at least a portion of a lower surface of the stator core and a coil wound around the stator core with the insulator interposed therebetween,
the circuit board is fixed to the insulator, and
a position where the circuit board is fixed to the insulator includes a position located radially outward of a midpoint between an outer edge of the circuit board and the center axis in a radial direction.

3. The motor according to claim 2, wherein the insulator includes an insulator body potion fixed to the lower surface of the stator core and a claw portion protruding downward from the insulator body potion,
the circuit board is fixed to the claw portion by snap fit, and
the insulator body potion and the claw portion are a one-piece member.

4. The motor according to claim 2, wherein the insulator includes a projection portion protruding downward from the insulator body potion, and
a coil wire which constitutes the coil extends to the circuit board via the projection portion.

5. The motor according to claim 1, wherein the upper motor cover includes a flange portion extending radially outward from a lower end of the tubular portion,
the upper motor cover is fixed to the lower motor cover in the flange portion, and
the lower end of the tubular portion is positioned axially above a lower end of the rotor magnet.

6. The motor according to claim 1, wherein the shaft is hollow,
the shaft extends downward beyond the circuit board, and
a hole portion communicating with the inside of the shaft is defined in a region of an outer circumferential surface of the shaft positioned axially below the circuit board.

7. The motor according to claim 6, further comprising:
a sensor substrate arranged to transmit a signal to the circuit board,
wherein the shaft is opened downward, and
the sensor substrate is arranged below the shaft.

8. The motor according to claim 1, wherein the bearing unit includes an upper bearing member arranged above the stator and a lower bearing member arranged below the stator,
the upper bearing member is fixed to the upper motor cover, and
the lower bearing member is fixed to the lower motor cover at a lower side of the circuit board.

9. The motor according to claim 1, wherein the lower motor cover is made of a resin,
the bearing unit includes an upper bearing member and a lower bearing member arranged axially below the upper bearing member, and
the upper bearing member and the lower bearing member are positioned axially above the stator.

10. The motor according to claim 9, wherein a nut is fixed to the lower motor cover, and
the upper motor cover and the lower motor cover are fixed to each other by tightening a bolt to the nut with the upper motor cover interposed between the bolt and the nut.

11. A ceiling fan, comprising:
the ceiling fan motor according to claim 1; and
a plurality of moving blades attached to the ceiling fan motor.

12. A ceiling fan motor, comprising:
a shaft centered at a center axis extending in an up-down direction;
a stator fixed to the shaft;
an upper motor cover having a tubular portion which surrounds the stator in a circumferential direction;
a bearing unit including at least one bearing member which rotatably supports the upper motor cover with respect to the shaft;
a lower motor cover attached to a lower portion of the upper motor cover;
a rotor magnet fixed to an inner surface of the tubular portion; and
a circuit board arranged below the stator,
wherein the stator includes a stator core, an insulator arranged to cover at least a portion of a lower surface of the stator core and a coil wound around the stator core with the insulator interposed therebetween,
the upper motor cover is a ferromagnetic body,
the circuit board includes a board body having a board surface which intersects the up-down direction, a rotation sensor attached to the board body and opposed to the rotor magnet in the up-down direction and a circuit component larger in mass than the rotation sensor,
if there is defined an imaginary line which is orthogonal, when seen in the up-down direction, to a line interconnecting the rotation sensor and the center axis and which passes through the shaft, a gravity center of the circuit board is positioned in one of two areas of the circuit board divided by the imaginary line, where the rotation sensor exists,
the circuit board is fixed to the insulator, and
a position where the circuit board is fixed to the insulator includes a position located radially outward of a midpoint between an outer edge of the circuit board and the center axis in a radial direction.

13. The motor according to claim 12, wherein the insulator includes an insulator body potion fixed to the lower surface of the stator core and a claw portion protruding downward from the insulator body potion,
the circuit board is fixed to the claw portion by snap fit, and
the insulator body potion and the claw portion are a one-piece member.

14. The motor according to claim 12, wherein the insulator includes a projection portion protruding downward from the insulator body potion, and
a coil wire which constitutes the coil extends to the circuit board via the projection portion.

15. The motor according to claim 12, wherein the upper motor cover includes a flange portion extending radially outward from a lower end of the tubular portion,
the upper motor cover is fixed to the lower motor cover in the flange portion, and
the lower end of the tubular portion is positioned axially above a lower end of the rotor magnet.

16. The motor according to claim 12, wherein the shaft is hollow,
the shaft extends downward beyond the circuit board, and
a hole portion communicating with the inside of the shaft is defined in a region of an outer circumferential surface of the shaft positioned axially below the circuit board.

17. The motor according to claim 16, further comprising:
a sensor substrate arranged to transmit a signal to the circuit board,
wherein the shaft is opened downward, and
the sensor substrate is arranged below the shaft.

18. The motor according to claim 12, wherein the bearing unit includes an upper bearing member arranged above the stator and a lower bearing member arranged below the stator,
the upper bearing member is fixed to the upper motor cover, and
the lower bearing member is fixed to the lower motor cover at a lower side of the circuit board.

19. The motor according to claim 12, wherein the lower motor cover is made of a resin,
the bearing unit includes an upper bearing member and a lower bearing member arranged axially below the upper bearing member, and
the upper bearing member and the lower bearing member are positioned axially above the stator.

20. The motor according to claim 19, wherein a nut is fixed to the lower motor cover, and
the upper motor cover and the lower motor cover are fixed to each other by tightening a bolt to the nut with the upper motor cover interposed between the bolt and the nut.

21. A ceiling fan, comprising:
the ceiling fan motor according to claim 12; and
a plurality of moving blades attached to the ceiling fan motor.
